(19) United States
(12) Patent Application Publication
(10) Pub. No.: US 2026/0153616 A1
(43) Pub. Date: Jun. 4, 2026

(54) Electromagnetic wave imaging method

(71) Applicant: CHENGDU INSTITUTE OF BIOLOGY, CHINESE ACADEMY OF SCIENCES, Chengdu, Sichuan (CN)

(72) Inventors: Haibo JIANG, Chengdu, Sichuan (CN); Yuan GAO, Chengdu, Sichuan (CN); Meng LI, Chengdu, Sichuan (CN)

(21) Appl. No.: 18/707,966

(22) PCT Filed: Oct. 20, 2023
(86) PCT No.: PCT/CN2023/125526

§ 371 Date: May 7, 2024

(30) Foreign Application Priority Data
Sep. 21, 2023 (CN) 202311229431.0

(51) Int. Cl. G01S 13/89

(52) U.S. Cl. CPC G01S 13/89

(57) ABSTRACT

The present application relates to the field of electromagnetic wave imaging technology, and specifically discloses an electromagnetic field imaging method, which mainly comprises: 1. constructing an imaging model; 2. Determining the element number N and the array pose based on the mode requirements for imaging and the actual size of the antenna, and calculating the circular array radius corresponding to each mode separately; 3. Controlling the system according to the array pose determined in step 2, the phase-shifting parameters of each element antenna, and the radius of the circular array; 4. Receiving the echoes corresponding to each pose with the receiving antenna, and forming a two-dimensional (2D) echo matrix based on the frequency and the mode; 5. Processing the echo signal to obtain a distance-azimuth 2D imaging result.

### TECHNICAL FIELD

The present application relates to electromagnetic wave imaging technology, and in particular to the field of radar imaging technology. Specifically, it relates to an electromagnetic wave imaging method.

### BACKGROUND

Orbital angular momentum (OAM) is another important physical quantity that distinguishes electromagnetic waves from other degrees of freedom such as phase, intensity, and frequency. Electromagnetic waves carrying OAM have richer {degrees-of-freedom} (DoFs) of modulating information compared to ordinary plane waves, and have been widely used in communication, radar imaging and other technical fields in recent years.

There are different methods to obtain electromagnetic waves (or electromagnetic fields) carrying OAM. Single antenna systems or multiple antenna systems can be used. The Chinese patent publication number CN111740223A (publication date: Oct. 2, 2020) has disclosed a method for obtaining electromagnetic waves carrying OAM using a circular array. Although the patent discloses a method for generating multimode electromagnetic fields, it does not provide an imaging technology solution for this electromagnetic field.

In the prior art, for the radar imaging mode of multiple transmitters and single receiver, there is no direct-current (DC) component in the echo envelope, making it impossible to use spectrum estimation ways to image at the target's azimuth. In related technical fields, conventional imaging methods require to know the elevation angle of the target in advance, and cannot image multiple targets at different elevation angles.

### CONTENT OF THE INVENTION

The main object of the present application is to provide an electromagnetic wave imaging method, so as to solve the problem of imaging the targets at unknown elevation angles.

In the present application, the radius of the circular antenna array is calculated based on the antenna frequency and electromagnetic wave mode information, so that the Bessel term in the echo signal is ≥0. Therefore, it is not necessary to know the elevation angle of the target to obtain the distance-azimuth 2D imaging of the target object.

In order to achieve the above object, according to one aspect of the present application, an electromagnetic wave imaging method is provided, characterized in that it comprises the following steps:
Step 1. Constructing an imaging model, which comprises N transmitting antennas and one receiving antenna, wherein the transmitting antennas form a uniform circular array, and the receiving antenna is used for receiving echo signals of targets; Nis the number of transmitting antennas (N≥1);
Step 2. Determining the number of transmitting antennas (N) and the array pose based on the mode requirements for imaging and the actual size of the antenna, and calculating the circular array radius corresponding to each mode separately;
Step 3. Controlling the imaging model according to the array pose determined in step 2, the phase-shifting parameters of each element antenna, and the radius of the circular array;
Step 4. Receiving the target echo signal corresponding to each pose with the receiving antenna; Step 5. Processing the echo signals of targets to obtain imaging results.

In some embodiments, the processing of the echo signal includes phase compensation preprocessing and imaging calculation.

In some embodiments, the imaging calculation is performed with spectrum estimation.

In some embodiments, the receiving antenna and/or transmitting antenna is made from a broadband antenna.

In some embodiments, in step 1, the overall moving imaging model places the target in the imaging area.

In some embodiments, in step 2:
for any normal model [symbol] ≥0, the radius [symbol] corresponding to a circular array is:

$${a}_{l} = \frac{{x}_{l}^{0}}{{k}_{max} sin ( {θ}_{max} )}$$

for any negative mode [symbol] <0, the radius aₗ corresponding to the circular array is [symbol] = [symbol] ;
wherein,

$${x}_{l}^{0}$$

is the first zero point of the l-order Bessel function [symbol] (x) in the range of x>0; [symbol] is the mode number, kₘₐₓ is the spatial wave number corresponding to the highest frequency used for transmitting antenna imaging, θₘₐₓ is the maximum value of the target elevation angles

$$( {θ}_{max} \leq \frac{π}{2} ) .$$

In some embodiments, in step 1, the number of transmitting antennas N is less than the maximum number of antennas that the array with a radius of a₀ can accommodate.

In some embodiments, in step 1, the minimum number M of antennas required is calculated based on the highest mode:

$$M = ( {l}_{max} + 1 ) \times 2 ;$$

wherein [symbol] is the maximum number of modes.

In some embodiments, in step 2, the number of poses required for the array is P,

$$P \geq ⌈ \frac{M}{N} ⌉ ,$$

wherein ┌⋅┐ indicates rounding up to the next number.

In some embodiments, the transmitting antennas are circular polarization antennas, and in step 2, the p-th pose of the array means the array orbits around the center of the array

$$( p - 1 ) \frac{2 π}{NP} ,$$

wherein p=1, 2, . . . , P.

In some embodiments, the transmitting antennas are linear polarization antennas, and in step 2, the p-th pose of the array means the array orbits around the center of the array

$$( p - 1 ) \frac{2 π}{NP} ,$$

wherein p=1, 2, . . . , P, and at the same time, each transmitting antenna rotates in the opposite direction

$$( p - 1 ) \frac{2 π}{NP} ,$$

wherein p=1, 2, . . . , P.

In some embodiments, for the p-th pose, the phase shift parameter of the n-th transmitting antenna is φₙ,

$${φ}_{n} = l [ \frac{2 π ( n - 1 )}{N} + \frac{2 π ( p - 1 )}{NP} ] .$$

In some embodiments, the phase compensation means that when [symbol] is a negative odd number, the compensation angle is n.

According to the technical solution of the present application and further improved technical solutions in certain exemplary examples, the present application has the following beneficial effects:

The imaging method of the present application does not require knowing the elevation angle of the target to achieve the distance-azimuth imaging of the target, by adjusting the array radius and allowing the symbol of the Bessel term in the echo signal not to change in a certain range of elevation angles. It can also simultaneously image multiple targets at different elevation angles. The technical solution of the present application can be applied in many fields such as radar imaging, earth observation, and biomedical imaging.

The present application will be further illustrated by reference to the accompanying drawings and following examples. The additional aspects and advantages of this application will be partially provided in the following description, and part of them will become apparent from the following description or be appreciated by the practice of this application.

### DESCRIPTION OF THE DRAWINGS

The accompanying drawings, forming a part of the present application, are used to provide a further understanding on this application. The specific embodiments and illustrative examples of the present application as well as their illustrations are used to describe the present application, and are not to be construed as a limitation of the scope of the present application. In the accompanying drawings:

FIG. 1. The flowchart according to the specific embodiment of the present application.

FIG. 2. The schematic diagram of an imaging model according to the specific embodiment of the present application.

FIG. 3. The schematic diagram of positive order Bessel function curve before and after adjusting radius according to the specific embodiment of the present application; FIG. 3a shows the schematic diagram of positive order Bessel function curve before adjusting radius, while FIG. 3b shows the schematic diagram of positive order Bessel function curve after adjusting radius.

FIG. 4. The schematic diagram of single-target imaging results according to the specific embodiment of the present application.

FIG. 5. The schematic diagram of four-targets imaging results according to the specific embodiment of the present application.

### EXAMPLES

It should be noted that, without conflict, the specific embodiments, exemplary examples, and features thereof in the present application can be combined with each other. The present application will be illustrated by reference to the accompanying drawings and the following contents.

In order to facilitate a better understanding on the solutions of the present application by those skilled in the art, the following will provide a clear and complete description of the technical solutions in the specific embodiments and exemplary examples of the present application, with reference to the examples and the accompanying drawings. Obviously, the exemplary examples described are only a part of those according the present application, not all of them. Based on the specific embodiments and exemplary examples in the present application, without creative work, all other embodiments and examples obtained by one of ordinary skill in the art shall be all within the scope of the present invention.

### EXAMPLE

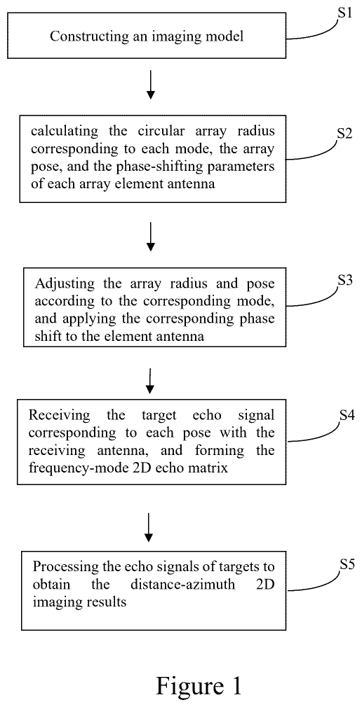

As shown in FIG. 1, the electromagnetic wave imaging method of this example comprises the following steps:
S1. Constructing an imaging model

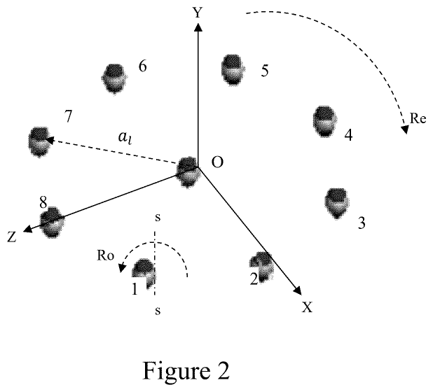

The imaging model of this example comprises eight transmitting antenna elements and one receiving antenna, and all of them located in the XOZ plane. The eight transmitting antennas are uniformly distributed around the OY axis, forming a uniform circular array. The receiving antenna is used to receive the echo signals of targets. In this example, the receiving antenna is located at the center of the array, that is, the center O position of the circular array, as shown in FIG. 2.

For the imaging model of this example, the difference in the signal intensity and signal delay between target echoes received by the receiving antenna at different azimuth angles is small, which is beneficial for improving the imaging effect of the targets.

In this example, eight transmitting antennas and one receiving antenna are all composed of the same structure of half-wave dipole antennas, that are broadband antennas with a working frequency of 5-6 GHz.

S2. Determining the number of transmitting antennas (N) and the array pose based on the mode requirements for imaging and the actual size of the antenna, and independently calculating the circular array radius corresponding to each mode and the phase-shifting parameters of each array element antenna

In this step, the highest frequency used for antenna imaging was set to 6 GHZ, and the circular array radius corresponding to each mode [symbol] was calculated.

Considering the current specifications of phase shifters, in this example, the mode used for imaging is set to be integers of [−7,7], the first zero point of the 1-7th order Bessel function [symbol] (x) in the range of x>0 is calculated, which was approximately:

$${x}_{1}^{0} = 3.8317 ; {x}_{2}^{0} = 5.3156 ; {x}_{3}^{0} = 6.3802 ; {x}_{4}^{0} = 7.5883 ; {x}_{5}^{0} = 8.7715 ; {x}_{6}^{0} = 9.9361 ; {x}_{7}^{0} = 11 \text{.0864} .$$

According to the properties of Bessel functions [symbol] (x)=(−1) [symbol] (x), the first zero point of a negative order Bessel function is determined to be the same as that of the corresponding positive order, that is,

$${x}_{l}^{0} = {x}_{\vert l \vert}^{0} , l < 0 .$$

### Herein,

$${x}_{l}^{0}$$

is the first zero point of the [symbol] -order Bessel function [symbol] (x), wherein x is the independent variable.

According to the properties of Bessel functions, positive-order Bessel functions are all ≥0 in the range of

$$( 0 , {x}_{l}^{0} ] ,$$

that is, provided that kasin

$$θ \leq {x}_{l}^{0} ,$$

the Bessel function [symbol] (kasin θ) is ≥0. Also since kasin θ corresponds to θ∈[0,π/2], k, a, sin θ all belong to increasing functions, and thus the maximum value of kasin θ is just ensured to be less than or equal to

$${x}_{l}^{0} \{ max ( kasin θ ) \leq {x}_{l}^{0} \} ,$$

i.e.

$$a \leq \frac{{x}_{l}^{0}}{{k}_{max} sin {θ}_{max}} ,$$

in which the maximum value is the array radius

$${a}_{l} = \frac{{x}_{l}^{0}}{{k}_{max} sin ( {θ}_{max} )}$$

corresponding to mode [symbol] , wherein kₘₐₓ is the spatial wave number corresponding to the highest frequency used for transmitting antenna imaging, [symbol] is the corresponding circular array radius, and θₘₐₓ is the maximum elevation angle set.

According to the properties of Bessel functions, the first zero point of J₀(x) in the range of x>0 is about 2.405, provided that x∈[0,2.405], J₀(x)≥0, and the maximum value is the array radius

$${a}_{0} = \frac{2.405}{{k}_{max} sin ( {θ}_{max} )}$$

corresponding to mode 0.

Setting

$${θ}_{max} = \frac{π}{4} ,$$

based on the spatial wave number corresponding to the highest frequency 6 GHz used for transmitting antenna imaging kₘₐₓ=125.7507, the radius a₀ is obtained by calculation as follows:
corresponding to mode 0, the radius

$${a}_{0} = \frac{2.405}{{k}_{max} sin ( {θ}_{max} )} = 0.025 ;$$

As for any negative mode ( [symbol] <0), the radius [symbol] corresponding to a circular array is [symbol] = [symbol] , and thus the radius corresponding to any negative mode [symbol] can be obtained, that is, provided that [symbol] is −1, −2 . . . −7, then a₋₁=a₁, a₋₂=a₂ . . . a₋₇=a₇.

As for any positive mode ( [symbol] >0), each mode in a circular array has a corresponding radius

$${a}_{l} = \frac{{x}_{l}^{0}}{{k}_{max} sin ( {θ}_{max} )} ,$$

the calculation results are as follows:
a₁=a₋₁=0.0431; a₂=a₋₂=0.0598; a₃=a₋₃=0.0718; a₄=a₋₄=0.0853; a₅=a₋₅=0.0986; a₆=a₋₆=0.1117; a₇=a₋₇=0.1247.

Based on the maximum number of modes used [symbol] =7, the minimum number of antennas required (M= [symbol] +1)×2=16) is calculated.

The number of poses required for the antenna array is determine as P,

$$P \geq ⌈ \frac{M}{N} ⌉ ,$$

wherein ┌⋅┐ indicates rounding up to the next number, i.e. P≥┌16/8┐=2. Thus, the minimum value is P=2, that is, the pose number for the antenna array is 2. The minimum value is used to simplify the imaging process. The larger P value, the more the rotation times, leading to an increase in imaging time and computational costs.

In this example, a circular array composed of 8 transmitting antennas is used, and rotated once around the center of the array, equivalent to the minimum number of antennas required for the highest mode, that can greatly save the number of antennas and simplify the system structure.

One of the transmitting antennas is selected as the initial element, and then all of the antennas are numbered clockwise as 1, 2, . . . , 8, as shown in FIG. 2.

In this example, the transmitting antennas are composed of circular polarization antennas. The p-th pose of the array means that the array rotates around the central axis OY by

$$( p - 1 ) \frac{2 π}{N P} ,$$

p=1, 2, . . . , P, that is, the antenna array rotates once, clockwise by 22.5°, as shown by the arrow Re in FIG. 2.

If the transmitting antennas are composed of linear polarization antennas, the array rotates around the array center O by

$$( p - 1 ) \frac{2 π}{N P} ,$$

p=1, 2, . . . , P, and at the same time, each transmitting antenna rotates

$$( p - 1 ) \frac{2 π}{N P} ,$$

p=1, 2, . . . , P, around the antenna rotation axis ss in the opposite direction, as shown by the arrow Ro in FIG. 2, so as to maintain the antenna imaging pose unchanged.

For the p-th pose, the phase shift caused by the n-th transmitting antenna is

$${φ}_{n} = l [ \frac{2 π ( n - 1 )}{N} + \frac{2 π ( p - 1 )}{M} ] ,$$

p=1,2, to generate electromagnetic waves corresponding to [symbol] mode.

Obviously, the number of transmitting antennas according to the present application is limited by the antenna size and array radius, which is less than the maximum number of antennas that the array can accommodate when the radius is a₀.

S3. Determining the array pose based on the above calculation results, adjusting the corresponding mode array radius, and applying corresponding phase shift to each element antenna

In this step, based on the calculated data above, the radius aₗ corresponding to each mode circular array and the rotation angle of corresponding array are determined, and the corresponding phase shift is applied to each transmitting antenna.

In this example, the rotational motion of the transmitting antenna array and the adjustment of the array radius are precisely driven by a computer-controlled servo system, and the data of the array motion is recorded by the computer system.

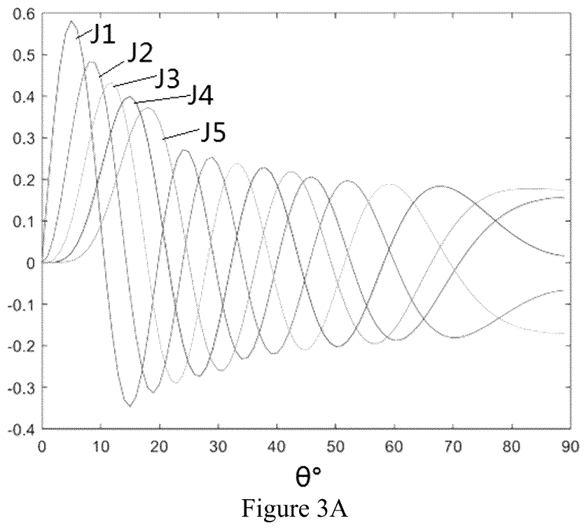

Comparing FIGS. 3a and 3b, it can be found that after adjusting the array radius, the Bessel function curves J₁, J₂, J₃, J₄, and J₅ are all positive values, indicating that the Bessel function symbol will not change, allowing the imaging method of the present application to achieve target imaging, even without the target elevation angle.
S4. receiving the target echo signal corresponding to each pose with the receiving antenna, and then forming the frequency-mode 2D echo matrix

The receiving antenna receives the echoes of all poses corresponding to mode l and adds them up, and thus the frequency-mode 2D echo data are obtained by traversing all modes.
S5. Processing the echo signals of targets to obtain the distance-azimuth 2D imaging results

The data corresponding to modes of −7, −5, −3, and −1 are multiplied by e^{iπ}, which is the compensation angle π, to obtain the compensated echo signal.

For the compensated echo signal, spectrum estimation such as 2D FFT (Fast Fourier Transform) is used to obtain the distance-azimuth imaging results.

In this example, a professional simulation software Feko is used for simulation, to obtain the frequency-mode 2D data, and then the calculation is carried out with the software Matlab.

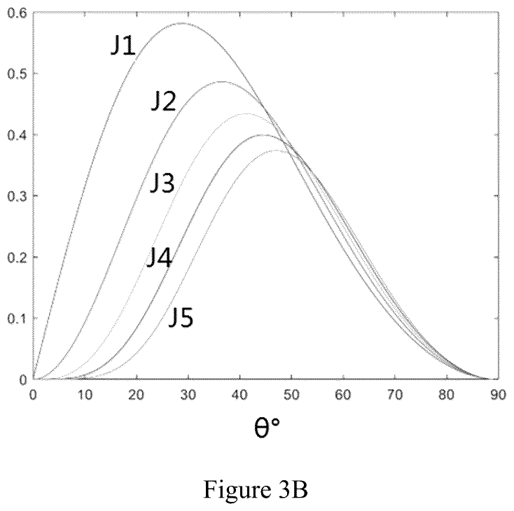

In the case of a single target, the imaging results are shown in FIG. 4:

| | |
|---|---|
| Shape and size | Circle with a radius of 0.02 m |
| Elevation angle | 40° |
| Azimuth | 90° |
| Distance | 1 m |

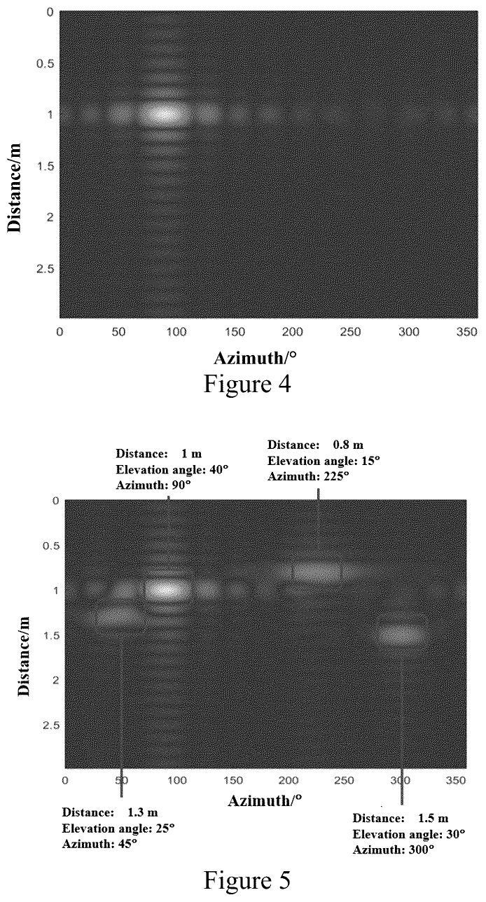

In the case of four targets, the imaging results are shown in FIG. 5:

| | | | | |
|---|---|---|---|---|
| Shape and | Circle with a | Circle with a | Circle with a | Circle with a |
| size | radius of 0.02 m | radius of 0.02 m | radius of 0.02 m | radius of 0.02 m |
| Elevation | 40° | 25° | 30° | 15° |
| angle | | | | |
| Azimuth | 90° | 45° | 300° | 255° |
| Distance | 1 m | 1.3 m | 1.5 m | 0.8 m |

Obviously, if the target is not in the radiation area of the electromagnetic wave, such as when the elevation angle of the target is extremely small or large, it is necessary to move the imaging model as a whole, change the center position of the array, and make the target in the imaging area for imaging.

1. An electromagnetic wave imaging method, characterized in that it comprises the following steps:
Step 1. Constructing an imaging model, which comprises N transmitting antennas and one receiving antenna, wherein the transmitting antennas form a uniform circular array, and the receiving antenna is used for receiving echo signals of targets; N is the number of transmitting antennas (N≥1);
Step 2. Determining the number of transmitting antennas (N) and the array pose based on the mode requirements for imaging and the actual size of the antenna, and calculating the circular array radius corresponding to each mode separately;
Step 3. Controlling the imaging mode according to the array pose determined in step 2, the phase-shifting parameters of each element antenna, and the radius of the circular array;
Step 4. Receiving the target echo signal corresponding to each pose with the receiving antenna;
Step 5. Processing the echo signals of targets to obtain imaging results.

2. The electromagnetic wave imaging method according to claim 1, characterized in that the processing of the echo signal includes phase compensation preprocessing and imaging calculation.

3. The electromagnetic wave imaging method according to claim 2, characterized in that the imaging calculation is performed with spectrum estimation.

4. The electromagnetic wave imaging method according to claim 1, characterized in that the receiving antenna and/or transmitting antenna is composed of a broadband antenna.

5. The electromagnetic wave imaging method according to claim 1, characterized in that in step 1, the overall moving imaging model places the target in the imaging area.

6. The electromagnetic wave imaging method according to claim 1, characterized in that in step 2:
for any normal mode [symbol] >0, the radius a [symbol] corresponding to a circular array is:
$${a}_{l} = \frac{{x}_{l}^{0}}{{k}_{max} sin ( {θ}_{max} )}$$
for any negative mode [symbol] <0, the radius [symbol] corresponding to the circular array is [symbol] = [symbol] ;
wherein,
$${x}_{l}^{0}$$
is the first zero point of the l-order Bessel function [symbol] (x) in the range of x>0; [symbol] is the mode number, kₘₐₓ is the spatial wave number corresponding to the highest frequency used for transmitting antenna imaging, θₘₐₓ is the maximum value of the target pitch angles
$$( {θ}_{max} \leq \frac{π}{2} ) .$$

7. The electromagnetic wave imaging method according to claim 6, characterized in that in step 1, the number of transmitting antennas N is less than the maximum number of antennas that the array with a radius of a₀ can accommodate.

8. The electromagnetic wave imaging method according to claim 6, characterized in that in step 1, the minimum number M of antennas required is calculated based on the highest mode:
$$M = ( {l}_{max} + 1 ) \times 2 ;$$
wherein [symbol] is the maximum number of modes.

9. The electromagnetic wave imaging method according to claim 8, characterized in that in step 2, the number of poses required for the array is P,
$$P \geq ⌈ \frac{M}{N} ⌉ ,$$
wherein ┌⋅┐ indicates rounding up to the next number.

10. The electromagnetic wave imaging method according to claim 9, characterized in that the transmitting antennas are circular polarization antennas, and in step 2, the p-th pose of the array means the array orbits around the center of the array
$$( p - 1 ) \frac{2 π}{N P} ,$$
wherein p=1, 2, . . . , P.

11. The electromagnetic wave imaging method according to claim 9, characterized in that the transmitting antennas are linear polarization antennas, and in step 2, the p-th pose of the array means the array orbits around the center of the array
$$( p - 1 ) \frac{2 π}{N P} ,$$
wherein p=1, 2, . . . , P, and at the same time, each transmitting antenna rotates in the opposite direction
$$( p - 1 ) \frac{2 π}{N P} ,$$
wherein p=1, 2, . . . , P.

12. The electromagnetic wave imaging method according to claim 10, characterized in that for the p-th pose, the phase shift parameter of the n-th transmitting antenna is
$${φ}_{n} , {φ}_{n} = l [ \frac{2 π ( n - 1 )}{N} + \frac{2 π ( p - 1 )}{N P} ] .$$

13. The electromagnetic wave imaging method according to claim 6, characterized in that the phase compensation means that when [symbol] is a negative odd number, the compensation angle is π.
